(19) United States
(12) Patent Application Publication
(10) Pub. No.: US 2007/0213516 A1
(43) Pub. Date: Sep. 13, 2007

(54) Process For Producing High-Purity Azo Dyes

(76) Inventors: Volker Hoellein, Frankfurt am Main (DE); Hieng Kim, Nidderau (DE); Lars Schneider, Kriftel (DE); Christian Wille, Weinheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/578,743

(22) PCT Filed: Apr. 6, 2005
(86) PCT No.: PCT/EP05/03597

§ 371 Date: Apr. 4, 2007

(30) Foreign Application Priority Data
Apr. 22, 2004 (DE) 10 2004 019 561.7

(51) Int. Cl. C09B 46/00; C09B 27/00

(52) U.S. Cl. 534/887; 430/108.23; 106/496; 106/402

(57) ABSTRACT

A process for producing high-purity azo colorants is characterized in that (a) at least the azo coupling is carried out in a micro-reactor, (b) the azo-dye produced in the micro-reactor is brought into intimate contact with an organic solvent from the group of the C₃-C₆ alcohols, the C₄-C₁₀ ether alcohols and the halogenated aromatics at a temperature from 0 to 60° C., and (c) the azo dye produced in the micro-reactor is subjected to membrane purification in an aqueous or solvent-containing suspension.

In the context of the present invention, azo colorants are sparingly soluble azo dyes and azo pigments which are prepared by the azo coupling reaction of a diazonium salt of an aromatic amine with a carbon acid compound, hereinafter referred to as coupling component.

Industrially, they are traditionally produced in batch processes. These processes all require accurate policing of process parameters in that, for example, temperature, time, commixing and colorant concentration, an example being the suspension concentration in the case of azo pigments, are decisive for the yield, the coloristic properties and the fastnesses of the azo colorants obtained and also for their consistency. Similarly, the scale-up of new products from the laboratory to manufacturing scale is costly and inconvenient for batch processes, and may cause difficulties, since, for example, tank and stirrer geometries or heat transfers have substantial influence on primary particle size, particle size distribution and coloristic properties.

Yet, despite all processing optimizations at synthesis, conventionally produced azo colorants do occasionally still contain, in their as-synthesized state, residual amounts of unconverted starting materials and also of by-products formed by secondary reactions.

Particularly for azo colorants used for non-impact printing processes, such as Small Office/Home Office printers, high chemical purity is an absolute prerequisite. For certain applications, such as the coloration of consumer articles for example, the colorants used have to meet specific limits for primary aromatic amines, naphthols and triazenes.

It is an object of the present invention to provide a technically reliable and economical process for producing azo colorants containing a distinctly reduced level of undesirable secondary components.

We have found that this object is achieved, surprisingly, by the combination of a pigment synthesis by micro reaction technology (MRT), solvent wash and membrane purification.

The present invention accordingly provides a process for producing high-purity azo colorants, which comprises
(a) conducting at least the azo coupling in a microreactor,
(b) intensively contacting the azo colorant produced in the microreactor with an organic solvent selected from the group of the C₃-C₆ alcohols, the C₄-C₁₀ ether alcohols and the halogenated aromatics at 0 to 60° C., and
(c) subjecting the azo colorant produced in the microreactor to a membrane purification in aqueous or solvent-containing suspension.

Step (c) can also be performed before step (b).

(a) Synthesis in Microreactor:

Useful microreactors include the apparatuses described in WO 01/59013 A1. A microreactor is constructed from a plurality of laminae which are stacked and bonded together and whose surfaces bear micromechanically created structures which cooperate to form reaction spaces for chemical reactions. The system contains at least one continuous channel connected to the inlet and the outlet. The flow rates of the streams of material are limited by the apparatus, for example by the pressures which result depending on the geometry of the microreactor. It is desirable for the microreactor reaction to go to completion, but it is also possible to adjoin a delay zone to create a delay time that may be required. The flow rates are advantageously between 0.05 and 5 l/min, preferably between 0.05 and 500 ml/min, more preferably between 0.05 and 250 ml/min and especially between 0.1 and 100 ml/min.

The microreaction system is operated continuously, and the quantities of fluid which are mixed with each other are in the microliter (μl) to milliliter (ml) range. The dimensions of the microstructured regions within the reactor are decisive for the synthesis of azo colorants in this microreaction system These dimensions have to be sufficiently large that, in particular, solid particles can pass without problem and so not clog up the channels. The smallest clear width of the microstructures should be about ten times larger than the diameter of the largest pigment particles. Furthermore, it has to be ensured, through appropriate geometric styling, that there are no dead water zones, for example dead ends or sharp corners, where pigment particles for example can sediment. Preference is therefore given to continuous paths having round corners. The structures have to be sufficiently small to exploit the intrinsic advantages of microreaction technology, namely excellent thermal control, laminar flow, diffusive mixing and low internal reaction volume.

The clear width of the solution- or suspension-ducting channels is advantageously 5 to 10 000 μm, preferably 5 to 2000 μm, more preferably 10 to 800 μm, especially 20 to 700 μm.

The clear width of the heat exchanger channels depends primarily on the clear width of the liquid- or suspension-ducting channels and is advantageously not more than 10 000 μm, preferably not more than 2000 μm and especially not more than 800 μm. The lower limit of the clear width of the heat exchanger channels is uncritical and is at most constrained by the pressure increase of the heat exchanger fluid to be pumped and by the necessity for optimal heat supply or removal.

The dimensions of the microreaction system used are:

heat exchanger structures: channel width about 600 μm, channel height: about 250 μm;

mixer and delay time: channel width about 600 μm, channel height about 500 μm.

The microreactor is preferably charged with all heat exchanger fluids and reactants from above. The product and the heat exchanger fluids are also preferably removed upwardly. The possible supply of third and fourth liquids involved in the reaction (buffer solutions being an example) is realized via a T-junction located directly upstream of the reactor, i.e., one reactant at a time can be mixed with the buffer solution in advance. The requisite concentrations and flows are preferably policed via precision piston pumps and a computer-controlled control system. The reaction temperature is monitored via integrated sensors and monitored and controlled with the aid of the control system and of a thermostat/cryostat.

The preparation of mixtures of input materials can also be carried out in advance in micromixers or in upstream mixing zones. It is also possible for input materials to be metered into downstream mixing zones or into downstream micromixers or -reactors.

The system used here is made of stainless steel; other materials, for example glass, ceramic, silicon, plastics or other metals, are similarly useful.

As well as the azo coupling, the diazotization, if appropriate a laking and/or a complexation with metal salts, can also be carried out in the microreactor. It is similarly possible for a plurality of these stages to be carried out in a corresponding number of successive microreactors.

The process of the present invention is useful for any sparingly soluble azo colorant preparable by azo coupling, for example for azo pigments from the series of the monoazo pigments, disazo pigments, β-naphthol and Naphthol AS pigments, laked azo pigments, benzimidazolone pigments, disazo condensation pigments and metal complex azo pigments; and for azo dyes from the series of the disperse dyes.

The process of the present invention also concerns the synthesis of precursors to the actual azo colorants by azo coupling. For example, precursors can be prepared to laked azo colorants, i.e., lakable azo colorants, to disazo condensation pigments, i.e., monoazo colorants linkable via a bifunctional group or, for example, disazo colorants extendable via an acid chloride intermediate, to formazan dyes, or other heavy metal azo dyes, examples being copper, chromium, nickel or cobalt azo dyes, i.e., azo colorants complexable with heavy metals.

Among the azo colorants preparable by the process of the present invention and the azo colorant precursors preparable by the process of the present invention, azo pigments are in particular C.I. Pigment Yellow 1, 3, 12, 13, 14, 16, 17, 65, 73, 74, 75, 81, 83, 97, 98, 106, 111, 113, 114, 120, 126, 127, 150, 151, 154, 155, 174, 175, 176, 180, 181, 183, 191, 194, 198, 213; Pigment Orange 5, 13, 34, 36, 38, 60, 62, 72, 74; Pigment Red 2, 3, 4, 8, 9, 10, 12, 14, 22, 38, 48:1-4, 49:1, 52:1-2, 53:1-3, 57:1, 60, 60:1, 68, 112, 137, 144, 146, 147, 170, 171, 175, 176, 184, 185, 187, 188, 208, 210, 213, 214, 242, 247, 253, 256, 262, 266, 269; Pigment Violet 32; Pigment Brown 25; if appropriate their precursors which are prepared by azo coupling.

Azo dyes are in particular C.I. Disperse Yellow 3, 23, 60, 211, 241; Disperse Orange 1:1, 3, 21, 25, 29, 30, 45, 53, 56, 80, 66, 138, 149; Disperse Red 1, 13, 17, 50, 56, 65, 82, 106, 134, 136, 137, 151, 167, 167:1, 169, 177, 324, 343, 349, 369, 376; Disperse Blue 79, 102, 125, 130, 165, 165:1, 165:2, 287, 319, 367; Disperse Violet 40, 93, 93:1, 95; Disperse Brown 1, 4 and if appropriate their precursors which are prepared by azo coupling.

It is advantageous to supply the reactants to the microreactor as aqueous solutions or suspensions and preferably in stoichiometric/equivalent amounts.

The azo coupling reaction takes place preferably in aqueous solution or suspension, although it is also possible to use organic solvents, alone or as a mixture with water; by way of example, alcohols having from 1 to 10 carbon atoms, examples being methanol, ethanol, n-propanol, isopropanol, butanols, such as n-butanol, sec-butanol, and tert-butanol, pentanols, such as n-pentanol and 2-methyl-2-butanol, hexanols, such as 2-methyl-2-pentanol, 3-methyl-3-pentanol, 2-methyl-2-hexanol and 3-ethyl-3-pentanol, octanols, such as 2,4,4-tri-methyl-2-pentanol, and cyclohexanol; or glycols, such as ethylene glycol, diethylene glycol, propylene glycol, dipropylene glycol, or glycerol; polyglycols, such as polyethylene glycols or polypropylene glycols; ethers, such as methyl isobutyl ether, tetrahydrofuran or dimethoxyethane; glycol ethers, such as monomethyl or monoethyl ethers of ethylene glycol or propylene glycol, diethylene glycol monomethyl ether, diethylene glycol monoethyl ether, butyl glycols or methoxybutanol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic or benzoic acid C₁-C₆ alkyl esters, such as ethyl benzoate; cyclic esters, such as caprolactone; nitriles, such as acetonitrile or benzonitrile; aliphatic or aromatic hydrocarbons, such as cyclohexane or benzene; or alkyl-, alkoxy-, nitro- or halo-substituted benzene, such as toluene, xylenes, ethylbenzene, anisole, nitrobenzene, chlorobenzene, o-dichlorobenzene, 1,2,4-trichlorobenzene or bromobenzene; or other substituted aromatics, such as benzoic acid or phenol; aromatic heterocycles, such as pyridine, morpholine, picoline or quinoline; and also hexamethylphosphoramide, 1,3-dimethyl-2-imidazolidinone, dimethyl sulfoxide, and sulfolane. Said solvents may also be used as mixtures. Preference is given to using water-miscible solvents.

Reactants used for the azo coupling reaction are diazonium salts of aromatic or heteroaromatic amines, such as, for example, aniline, 2-nitroaniline, methyl anthranilate, 2,5-dichloroaniline, 2-methyl-4-chloroaniline, 2-chloroaniline, 2-trifluoromethyl-4-chloroaniline, 2,4,5-trichloroaniline; 3-amino-4-methylbenzamide, 2-methyl-5-chloroaniline, 4-amino-3-chloro-N′-methylbenzamide, o-toluidine, o-dianisidine, 2,2′,5,5′-tetrachlorobenzidine, 2-amino-5-methylbenzenesulfonic acid, and 2-amino-4-chloro-5-methylbenzenesulfonic acid.

Of particular interest for azo pigments are the following amine components: 4-methyl-2-nitrophenylamine, 4-chloro-2-nitrophenylamine, 3,3′-dichlorobiphenyl-4,4′-diamine, 3,3′-dimethylbiphenyl-4,4′-diamine, 4-methoxy-2-nitrophenylamine, 2-methoxy-4-nitrophenylamine, 4-amino-2,5-dimethoxy-N-phenylbenzenesulfonamide, dimethyl 5-aminoisophthalate, anthranilic acid, 2-trifluoromethylphenylamine, dimethyl 2-aminoterephthalate, 1,2-bis(2-aminophenoxy)ethane, 2-amino-4-chloro-5-methylbenzenesulfonic acid, 2-methoxyphenylamine, 4-(4-aminobenzoylamino)benzamide, 2,4-dinitrophenylamine, 3-amino-4-chlorobenzamide, 3-amino-4-chlorobenzoic acid, 4-nitrophenylamine, 2,5-dichlorophenylamine, 4-methyl-2-nitrophenylamine, 2-chloro-4-nitrophenylamine, 2-methyl-5-nitrophenylamine, 2-methyl-4-nitrophenylamine, 2-methyl-5-nitrophenylamine, 2-amino-4-chloro-5-methylbenzenesulfonic acid, 2-aminonaphthalene-1-sulfonic acid, 2-amino-5-chloro-4-methylbenzenesulfonic acid, 2-amino-5-chloro-4-methylbenzenesulfonic acid, 2-amino-5-methylbenzenesulfonic acid, 2,4,5-trichlorophenylamine, 3-amino-4-methoxy-N-phenylbenzamide, 4-aminobenzamide, methyl 2-aminobenzoate, 4-amino-5-methoxy-2,N-dimethylbenzenesulfonamide, monomethyl 2-amino-N-(2,5-dichlorophenyl)terephthalate, butyl 2-aminobenzoate, 2-chloro-5-trifluoromethylphenylamine, 4-(3-amino-4-methylbenzoylamino)benzenesulfonic acid, 4-amino-2,5-dichloro-N-methylbenzenesulfonamide, 4-amino-2,5-dichloro-N,N-dimethylbenzenesulfonamide, 6-amino-1H-quinazoline-2,4-dione, 4-(3-amino-4-methoxybenzoylamino)benzamide, 4-amino-2,5-di-methoxy-N-methylbenzenesulfonamide, 5-aminobenzimidazolone, 6-amino-7-methoxy-1,4-dihydroquinoxaline-2,3-dione, 2-chloroethyl 3-amino-4-methylbenzoate, isopropyl 3-amino-4-chlorobenzoate, 3-amino-4-chlorobenzotrifluoride, n-propyl 3-amino-4-methylbenzoate, 2-aminonaphthalene-3,6,8-trisulfonic acid, 2-aminonaphthalene-4,6,8-trisulfonic acid, 2-aminonaphthalene-4,8-disulfonic acid, 2-aminonaphthalene-6,8-disulfonic acid, 2-amino-8-hydroxynaphthalene-6-sulfonic acid, 1-amino-8-hydroxynaphthalene-3,6-disulfonic acid, 1-amino-2-hydroxybenzene-5-sulfonic acid, 1-amino-4-acetylaminobenzene-2-sulfonic acid, 2-aminoanisole, 2-aminomethoxybenzene-ω-methanesulfonic acid, 2-aminophenol-4-sulfonic acid, o-anisidine-5-sulfonic acid, 2-(3-amino-1,4-dimethoxy-benzenesulfonyl)ethyl sulfate, and 2-(1-methyl-3-amino-4-methoxybenzenesulfonyl)ethyl sulfate.

The following coupling components are of particular interest for azo pigments: acetoacetarylides of the formula (I) 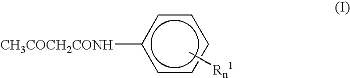
where

n is a number from 0 to 3, and

R¹ can be a C₁-C₄ alkyl group, such as methyl or ethyl; a C₁-C₄ alkoxy group, such as methoxy or ethoxy; a trifluoromethyl group; a nitro group; a halogen atom such as fluorine, chlorine or bromine; a NHCOCH₃ group; an SO₃H group; a group SO₂NR¹⁰R¹¹ where R¹⁰ and R¹¹ are identical or different and are hydrogen or C₁-C₄ alkyl; a group COOR¹⁰ where R¹⁰ is as defined above; or a group COONR¹²R¹³ where R¹² and R¹³ independently are hydrogen, C₁-C₄ alkyl or phenyl, the phenyl ring being substituted by one, two or three identical or different substituents from the group consisting of C₁-C₄ alkyl, C₁-C₄ alkoxy, trifluoromethyl, nitro, halogen, COOR¹⁰, R¹⁰ being as defined above, and COONR¹⁰R¹¹, R¹⁰ and R¹¹ being identical or different and being as defined above,

and where n>1 R¹ may be identical or different;

2-hydroxynaphthalenes of the formula (II) 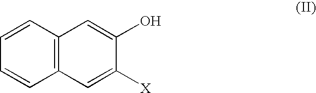
where
X is hydrogen, a COOH group or a group of the formula (III), (VI) or (VII); 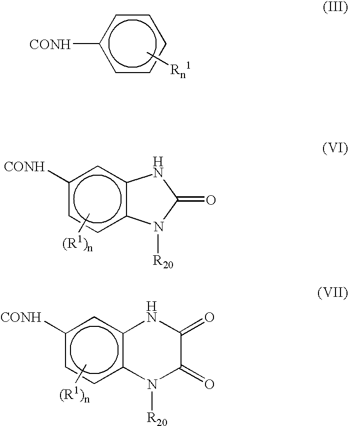
where n and R¹ are as defined above; and
R²⁰ is hydrogen, methyl or ethyl;
bisacetoacetylated diaminophenyls and -biphenyls, N,N′-bis(3-hydroxy-2-naphthoyl)phenylenediamines, in which the phenyl or biphenyl ring may be unsubstituted or substituted by 1, 2, 3 or 4 identical or different radicals CH₃, C₂H₅, OCH₃, OC₂H₅, NO₂, F, Cl, CF₃;
acetoacetarylides of dinuclear heterocycles of the formula (IV) 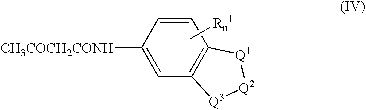
where n and R¹ are as defined above,

Q¹, Q² and Q³ may be identical or different and are N, NR², CO, N—CO, NR²—CO, CO—N, CO—NR², CH, N—CH, NR²—CH, CH—N, CH—NR², CH₂, N—CH₂, NR²—CH₂, CH₂—N, CH₂—NR² or SO₂, where

R² is a hydrogen atom; is a C₁-C₄ alkyl group, such as methyl or ethyl; or is a phenyl group which may be unsubstituted or substituted one or more times by halogen, C₁-C₄ alkyl, C₁-C₄ alkoxy, trifluoromethyl, nitro, cyano,
with the proviso that the combination of Q¹, Q² and Q³ with the two carbon atoms of the phenyl ring results in a saturated or unsaturated, five- or six-membered ring; preferably acetoacetarylides of the formula (VIa) and (VIIa) 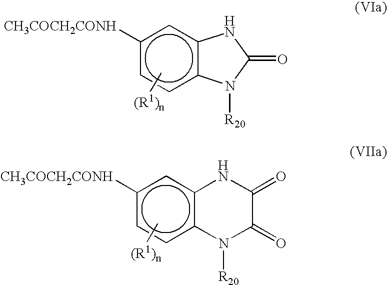
where R¹ and n are as defined above and R²⁰ is hydrogen, methyl or ethyl; and also pyrazolones of the formula (V) 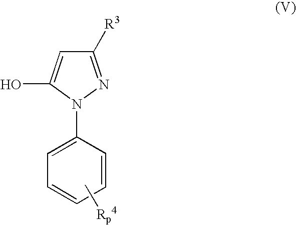
where

R³ is a CH₃, COOCH₃ or COOC₂H₅ group,

R⁴ is a CH₃ or SO₃H group or a chlorine atom, and

p is a number from 0 to 3,

and where p>1 R⁴ may be identical or different.

Particular preference for the purposes of the present invention is given to the preparation of the so-called anisbase pigments of the formula (VI) 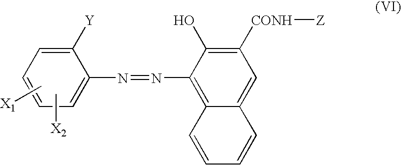
where

X₁ is hydrogen, halogen, in particular chlorine, nitro, carbamoyl, phenylcarbamoyl, sulfamoyl, phenylsulfamoyl or (di)alkylsulfamoyl;

X₂ is hydrogen or halogen, in particular chlorine;

Y is hydrogen, halogen, in particular chlorine, nitro, C₁-C₄-alkyl, C₁-C₄-alkoxy or C₁-C₄-alkoxycarbonyl; and

Z is hydrogen, phenyl, naphthyl, benzimidazolonyl or halogen-, in particular chlorine-, nitro-, C₁-C₄-alkyl- and/or C₁-C₄-alkoxy-substituted phenyl.

The process of the present invention may also utilize the auxiliaries that are employed in conventional processes, for example surfactants, pigmentary and nonpigmentary dispersants, fillers, standardizers, resins, waxes, defoamers, antidust agents, extenders, shading colorants, preservatives, drying retardants, rheology control additives, wetting agents, antioxidants, UV absorbers, photostabilizers or a combination thereof.

The auxiliaries may be added at any point in time before, during or after the reaction in the microjet reactor, all at once or in two or more portions. The auxiliaries may, for example, be added directly to the reactant solutions or suspensions, or else during the reaction in liquid, dissolved or suspended form. The overall amount of the added auxiliaries may amount to from 0 to 40% by weight, preferably from 1 to 30% by weight, more preferably from 2.5 to 25% by weight, based on the azo colorant.

Suitable surfactants include anionic or anion-active, cationic or cation-active, and nonionic substances or mixtures of these agents.

Examples of surfactants, pigmentary and nonpigmentary dispersants which can be used for the method of the invention are specified in EP-A-1 195 411.

Since compliance with a desired pH value during and after the reaction is often decisive for quality, it is also possible to supply buffer solutions, preferably of organic acids and salts thereof, such as formic acid/formate buffers, acetic acid/acetate buffers, citric acid/citrate buffers; or of inorganic acids and salts thereof, such as phosphoric acid/phosphate buffers or carbonic acid/hydrogencarbonate or carbonate buffers, for example.

With the process of the invention it is also possible, through the use of more than one diazonium salt and/or of more than one coupling component, to prepare mixtures or else mixed crystals of azo colorants.

(b) Solvent Wash:

The solvent wash of the present invention comprises the take-up in one of the organic solvents mentioned of the azo colorant prepared in step (a), either directly from the microreactor or after intervening isolation for example as a presscake (solids content about 5% to 30% by weight).

Preferred solvents here are C₃-C₄ alcohols, glycol ethers and chlorinated benzenes, for example butoxyethanol, orthodichlorobenzene, isobutanol, isopropanol, or a mixture thereof.

It is also possible to use a pigment suspension treated as per (c).

The amount of solvent is preferably in the range from 1% to 30% by volume and in particular in the range from 5% to 15% by volume, based on the volume of the pigment suspension, or 1 to 10 times the weight of solvent, based on the weight of the pigment in the presscake.

The mixture of pigment suspension or presscake and solvent is preferably stirred at between 10° C. and 50° C. and especially between 20° C. and 45° C. for preferably 0.1 to 2 hours and especially 0.25 to 1 hour and preferably at atmospheric pressure.

Normal stirring apparatus can be used, such as laboratory stirrers for example. However, it is also possible in principle to use an inline dispersing machine fitted with appropriate dispersing tools, in the pumped circulation system of the feed vessel. Such a dispersing machine not only ensures an intensive commixing of the suspension in the feed vessel, but also has a deagglomerating effect, so that any inclusions are laid bare.

The solvent-treated azo colorant suspension is subsequently filtered and washed or fed directly, without intervening isolation, to the membrane purification stage (c).

(c) Membrane Purification:

The membrane purification stage of the present invention comprises passing an azo colorant suspension obtained from step (a) or from (b) through a membrane system constituted such that the azo colorant is held back by the membrane as completely as possible. The liquid medium can be in particular water or else an organic solvent, if appropriate in admixture with water. The solids concentration in the suspension is advantageously in the range from 1% to 10% by weight and preferably in the range from 2% to 5% by weight, based on the total weight of the suspension. The driving force for transmembrane transport is a pressure difference between the two sides of the membrane. The pressure difference is advantageously in the range from 0.5 to 5 bar and preferably in the range from 1 to 2 bar. The pressure is generated by suitable pumps for example, examples being piston pumps. The membranes used are for example ceramic or polymeric membranes having typical separation limits between 100 and 10⁶ g/mol. Preference is given to using static membrane modules, such as tubular or plate modules, or dynamic membrane modules. The temperature is advantageously in the range from 0 to 100° C. and particularly within the range from 20 to 80° C.

The membrane purification can also be carried out as a diafiltration. In this case, the retentate, i.e., the azo colorant, is recycled into the original vessel and the water or solvent content is kept constant by replenishment. The process of the present invention provides the following product improvements compared with a traditional optimized batch operation:

Step (a) lowers the level of anisbase and mixed triazenes significantly, i.e., down to below the detection limit of 50 ppm, but over 100 ppm of free aromatic amine and of unconverted coupling components, for example naphthol, are usually still present.

Step (b) combined with step (c) surprisingly provides a lowering of the free amine and naphthol content below the detection limits of 25 ppm and 100 ppm, respectively.

Inorganic salts are likewise retained as a side effect of membrane purification.

The level of secondary components is determined by customary HPLC methods.

The high-purity azo colorants prepared according to the present invention are used in particular for coloration of electrophotographic toners and developers, for example one- or two-component powder toners (also known as one- or two-component developers), magnetic toners, liquid toners, latex toners, addition polymerization toners and also specialty toners, of powder coatings, of ink jet inks and color filters and also as colorants for “electronic inks” (“e-inks”) or “electronic paper” (“e-paper”).

The invention therefore also provides a process for coloring electrophotographic toners and developers, which comprises a high-purity azo colorant prepared according to steps (a), (b) and (c) being incorporated homogeneously in a toner binder in an amount of 0.05% to 30% by weight and preferably 0.1% to 15% by weight, based on the total weight of the toner or developer. Typical toner binders are addition polymerization, polyaddition and polycondensation resins, such as styrene, styrene-acrylate, styrene-butadiene, acrylate, polyester, phenol-epoxy resins, polysulfones, polyurethanes, individually or in combination, and also polyethylene and polypropylene, which may each contain further ingredients, such as charge control agents, waxes or flow assistants, or are subsequently modified with these additives.

The invention further provides a process for coloring ink jet inks, which comprises high-purity azo colorant prepared according to steps (a), (b) and (c) being incorporated homogeneously in the ink base in an amount of 0.5% to 15% by weight and preferably 1.5% to 8% by weight, based on the total weight of the ink jet ink.

Ink jet inks include those on an aqueous basis and on a nonaqueous basis, microemulsion inks, UV-curable inks and also such inks as operate by the hot melt process.

The ink base of microemulsion inks is based on organic solvents, water and if appropriate an additional hydrotropic substance (interfacial mediator).

The ink basis of solvent-based ink jet inks is based on organic solvents and/or a hydrotropic compound and if appropriate a carrier material which is soluble in the solvent, examples being polyolefins, natural and synthetic rubber, polyvinyl chloride, vinyl chloride/vinyl acetate copolymers, polyvinyl butyrals, wax/latex systems or combinations thereof.

The ink base of UV-curable inks is based on water, organic solvent, a radiation-curable binder and if appropriate a photoinitiator.

The ink base of hot melt inks is usually based on waxes, fatty acids, fatty alcohols or sulfonamides, which are solid at room temperature and become liquid on heating, the preferred melting range being between about 60 and about 140° C.

The invention further provides a process for coloring color filters not only for additive but also for subtractive color production, which comprises a high-purity azo colorant prepared according to steps (a), (b) and (c) being applied in the form of a paste or as a pigmented photoresist in suitable binders (acrylate salts, acrylic esters, polyimides, polyvinyl alcohols, epoxides, polyesters, melamines, gelatin, caseins) to the respective LCD components (for example TFT-LCD=Thin Film Transistor Liquid Crystal Displays or for example ((S) TN-LCD=(Super) Twisted Nematic-LCD). As well as a high thermal stability, a high pigment purity is also a prerequisite for a stable paste or a pigmented photoresist.

The azo colorants prepared according to the present invention are obviously also useful for coloring natural or synthetic macromolecular organic materials of any kind, examples being cellulose ethers and esters, such as ethylcellulose, nitrocellulose, cellulose acetate or cellulose butyrate, natural resins or artificial resins, such as addition polymerization resins or condensation resins, for example amino resins, in particular urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, lattices, silicones and silicone resins, individually or in mixtures.

The macromolecular organic compounds mentioned can be present as plastically deformable masses, casting resins, pastes, melts or in the form of spinning solutions, lacquers, glazes, foams, graphic inks, jetable inks, stains, paints, including emulsion paints, or nonjetable printing inks.

### EXAMPLE 1

### C.I. Pigment Red 269

a1) Preparation of an Anisbase Diazonium Salt Solution:

242 g of 3-amino-4-methoxybenzanilide are initially stirred homogeneously into an initial charge of 2532 g of water at room temperature, precipitated by addition of hydrochloric acid and cooled down to 10° C. with 1.5 kg of ice/water. The precipitated hydrochloride is diazotized with 138 ml of sodium nitrite solution (40%) to finally give a readily stirrable anisbase diazo solution. This solution has a clarifying aid added to it and is subsequently filtered off into a feed vessel. Excess nitrite is removed by addition of amidosulfonic acid.

A2) Preparation of a Buffer for the Anisbase Diazonium Salt Solution:

To an initial charge of 1884 g of ice/water are added 502 g of acetic acid and also 614 g of aqueous sodium hydroxide solution, and the temperature is held at room temperature after addition of 1 kg of water.

A3) Preparation of a Solution of the Coupling Component (Naphthol):

An initial charge of 2720 g of water containing a wetting aid is heated to 80° C. While stirring, 328 g of N-(5-chloro-2-methoxyphenyl)-3-hydroxynaphthalene-2-carboxamide are introduced and dissolved alkalinically. By addition of a further 2720 g of ice/water, the Naphthol AS solution is cooled down to room temperature. It is finally filtered by addition of a clarifying aid.

a4) Azo Coupling in Microreactor:

The anisbase diazonium salt solution and the Naphthol AS solution are pumped at a flow rate of 8 ml/min into the respective reactant inlets of the microreactor (type: Cytos from CPC-Systems/Frankfurt). To achieve the requisite pH of 4.8-5.0 for azo coupling, the reactant solutions are diluted with the acetic acid/acetate buffer prepared according to a2), shortly upstream of the reactor inlets. The buffer solution is likewise conveyed with the aid of calibrated piston pumps via a T-junction into the reactant feed lines of the microreactor at a flow rate of 6 ml/min in each case. The heat exchanger circuit of the microreactor is connected to a thermostat which sets the desired reaction temperature of 20° C. to 35° C. The coupled pigment suspension (21° C., pH=5.0) is collected in a feed vessel and subjected to the following solvent wash.

b) Solvent Wash:

The pigment suspension obtained from the microreactor is admixed with such an amount of butoxyethanol that the entire slurry contains about 10% by volume of butoxyethanol. The slurry is stirred at about 45° C. for 30 minutes, filtered off and washed with water. After sampling, the colorant-solvent-water suspension is subjected to the following membrane purification.

c) Membrane Purification:

A ceramic multichannel microfiltration membrane having a nominal separation limit of 60 nm for the separation-selective layer and a membrane area of 0.09 m² is used. About 15 kg of the colorant suspension having a pigment content of about 2% by weight are charged to a temperature-controllable feed vessel. The membrane is subjected to a pressure of about 1.5 bar on the retentate side at ambient temperature. To ensure a constant volume in the feed vessel, the mass of permeate removed is replaced with demineralized water in a discontinuous manner.

The pigment is fully retained and the organic secondary components are reduced to the values listed in table 2, under these conditions. The exchange volume (i.e., volume of demineralized water supplied/volume of pigment suspension used) is about 4. Permeate flux is about 200 l/(m²·h·bar).

At the same time, the initial chloride ion content of 2.5% is reduced by 10 hours of diafiltration to 920 ppm as is the sulfate content from initially 0.3% to 30 ppm.

d) Analysis:

The samples taken (each 0.5 g) are dried, admixed with 10 ml each of N-methylpyrrolidone and comminuted for 15 min by ultrasonication. After addition of 20 ml of methanol and renewed grinding for 15 min, the suspension is filtered off. In each case, 20 μl of the filtrate are introduced into the autosampler of the HPLC system and detected by UV-V is detector at 240 and 375 nm (separating column Nucleosil 120-5 C18 (length: 25 cm, Øᵢ=4.6 mm); mobile phase consisting of a buffer (575 mg of NH₄H₂PO₄ plus 1000 g of H₂O plus 3.0 g of NaN₃ (pH 5.0)) and methanol ®chromasolv in various compositions for a total flux of 1 ml/min).

Table 2 Lists the Levels of Secondary Components after Each Step:

Table 2 shows a comparison of the typical secondary component levels of the conventional batch pigment with the secondary component levels of the pigment from a synthesis in a microreactor [step (a)] and subsequent solvent wash [step (b)] and membrane purification [step (c)].

The detection limits for the secondary components considered are listed in table 1 to categorize and assess the values in table 2. The measuring accuracy of the analytical method chosen is about ±5 pp.

TABLE 1
Detection limits for secondary components:

| Secondary component | Detection limit |
|---|---|
| Anisbase | 25 ppm |
| Chloromethoxyaniline | 50 ppm |
| Anisbase triazenes | 50 ppm |
| Mixed triazenes | 50 ppm |
| Naphthol AS-CA | 100 ppm |

TABLE 2
Comparison of secondary component levels in pigment from batch
synthesis versus microreactor synthesis with subsequent solvent
wash and membrane purification.

| | | | Pigment | Pigment |
|---|---|---|---|---|
| | | | after | after |
| | | Pigment | solvent | membrane |
| | Batch | after | wash | purification |
| | pigment | [step a)] | [step b)] | [step c)] |
| Anisbase | 132 ppm | 100 ppm | 80 ppm | 60 ppm |
| Chloromethoxyaniline | 54 ppm | 50 ppm | n.d.* | n.d.* |
| Anisbase triazenes | 134 ppm | n.d.* | n.d.* | n.d.* |
| Mixed triazenes | 138 ppm | n.d.* | n.d.* | n.d.* |
| Naphthol AS-CA | 250 ppm | <100 ppm | <100 ppm | <100 ppm |

*not detectable, i.e., smaller than detection limit of table 1.

### EXAMPLE 2

### C.I. Pigment Red 146

Steps a)-d) are carried out similarly to Example 1. The pigment obtained after step c) had anisbase, chloromethoxyaniline, anisbase triazene and Naphtol AS levels below the respective limit of detection.

### EXAMPLE 3

### C.I. Pigment Red 147

Steps a)-d) are carried out similarly to Example 1. The pigment obtained after step c) had anisbase, chloromethoxyaniline, anisbase triazene and Naphtol AS levels below the respective limit of detection.

### COMPARATIVE EXAMPLES 2 AND 3

Average values of altogether 80 batch syntheses:

| Anisbase | 519 ppm |
|---|---|
| Chloromethoxyaniline | 32 ppm |
| Anisbase triazene | 446 ppm |
| Naphtol AS | 1.10% |

### EXAMPLE 4

### C.I: Pigment Yellow 213

a1) Preparation of a Dimethyl Aminoterephthalate Diazonium Salt Solution:

An initial charge of 209 g of aminoterephthalic dimethyl ester (ATDME) in 270 g of water is stirred overnight until homogeneous. The next day, hydrochloric acid is added before cooling down to 10° C. with ice/water. Diazotization of the hydrochloride with 132 ml of sodium nitrite solution (40%) finally gives a readily stirrable ATDME diazo solution. This solution has a clarifying aid added to it and is subsequently filtered off into a feed vessel. Excess nitrite is removed by addition of amidosulfonic acid.

a2) Preparation of a Suspension of the Coupling Component in Water

The coupler N-acetoacetyl-6-methoxy-7-aminoquinoxaline-2,3-dione, suspended in water, is only dissolved in situ shortly before the actual coupling.

a3) Preparation of a Buffer for the ATDME Diazo Solution:

500 g of water are introduced as initial charge, 432 g of acetic acid and also 190 g of aqueous sodium hydroxide solution are added and the temperature is maintained at room temperature after addition of 1 kg of water.

Provision of dilute aqueous sodium hydroxide solution (0.5 to 5.0 mol/kg) for azocoupling reaction in microreactor.

A4) Azo Coupling in Microreactor

The ATDME diazo solution and the aqueous coupler suspension are pumped at a flow rate of 13 ml/min into the respective reactant inlets of the microreactor. To make the coupling component, suspended in water, go into solution in situ, a dilute sodium hydroxide solution (3%) is likewise conveyed into the coupler feed line of the microreactor by means of a calibrated piston pump via a T-junction. To achieve the requisite pH of 4.0-4.5 for azo coupling, the ATDME diazo solution is diluted with an acetic acid/acetate buffer prepared according to a3) shortly upstream of the microreactor inlets. The buffer solution is likewise conveyed by means of a calibrated piston pump via a T-junction at a flow rate of 4 ml/min into the diazo feed line of the microreactor. The heat exchanger circuit of the microreactor is connected to a thermostat which sets the desired reaction temperature of 20° C. to 35° C. The coupled pigment suspension is collected in a receiver and isolated.

Steps b)-d) were carried out similarly to Example 1.

C.I. Pigment Yellow 213

| | Pigment after | Pigment after |
|---|---|---|
| | [step a)] #1 | [step c)] #1 |
| Iron | 78 ppm | 20 ppm |
| Zinc | 12 ppm | 7 ppm |
| Magnesium | 76 ppm | 8 ppm |
| Sodium | 140 ppm | 80 ppm |
| Calcium | 430 ppm | 73 ppm |
| Aluminum | 33 ppm | 16 ppm |
| Potassium | 29 ppm | 22 ppm |
| Chloride | 168 ppm | <50 ppm |
| Sulfate | 102 ppm | <50 ppm |
| Phosphate | <50 ppm | <50 ppm |
| Nitrate | <50 ppm | <50 ppm |
| Formate | <50 ppm | <50 ppm |
| Acetate | 90 ppm | <50 ppm |
| Bromide | <50 ppm | <50 ppm |
| Sulfite | <50 ppm | <50 ppm |
| Nitrite | <50 ppm | <50 ppm |

#1: target limit <100 ppm

1) A process for producing a high-purity azo colorant comprising the steps of:
(a) conducting at least the azo coupling in a microreactor,
(b) intensively contacting the azo colorant produced in the microreactor with at least one organic solvent at a temperature of from 0 to 60° C., wherein the solvent is selected from the group consisting of C₃-C₆ alcohols, C₄-C₁₀ ether alcohols and halogenated aromatics at, and
(c) subjecting the azo colorant produced in the microreactor to a membrane purification in aqueous or solvent-containing suspension.

2) The process according to claim 1 wherein step (a) is carried out first, followed by step (c) and then step (b).

3) The process according to claim 1 wherein step (b) is carried out at a temperature between 20° C. and 45° C.

4) The process according to claim 1, wherein the at least one organic solvent is butoxyethanol, orthodichlorobenzene, isobutanol, isopropanol or a mixture thereof.

5) The process according to claim 1, wherein step (c) utilizes ceramic or polymeric membranes having separation limits between 100 and 10⁶ g/mol.

6) The process according to claim 1, wherein step (c) is conducted by recycling the azo colorant as retentate and keeping the water or the solvent content of the suspension constant by replenishment.

7) The process according to claim 1, wherein the azo colorant is an azo pigment selected from the group consisting of monoazo pigments, disazo pigments, β-naphthol pigments Naphthol AS pigments, laked azo pigments, benzimidazolone pigments, disazo condensation pigments and metal complex azo pigments.

8) The process according to claim 1, wherein the azo colorant is a disperse dye.

9) The process according to claim 1, wherein the azo colorant is an anisbase pigment of the formula (VI) 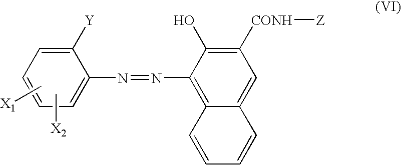
wherein
X₁ is hydrogen, halogen, nitro, carbamoyl, phenylcarbamoyl, sulfamoyl, phenylsulfamoyl or (di)alkylsulfamoyl;
X₂ is hydrogen or halogen;
Y is hydrogen, halogen, nitro, C₁-C₄-alkyl, C₁-C₄-alkoxy or C₁-C₄-alkoxycarbonyl; and
Z is hydrogen, phenyl, naphthyl, benzimidazolonyl or halogen-, nitro-, C₁-C₄-alkyl- or C₁-C₄-alkoxy-substituted phenyl.

10) A high purity azo colorant made in accordance with the process of claim 1.

11. A composition comprising an azo colorant according to claim 10, wherein the composition is selected from the group consisting of electrophotographic toners, electrophotographic developers, magnetic toners, liquid toners, latex toners, addition polymerization toners, specialty toners, powder coatings, ink jet inks, color filters electronic inks and electronic papers.
